(19) United States
(12) Patent Application Publication
(10) Pub. No.: US 2013/0051210 A1
(43) Pub. Date: Feb. 28, 2013

(54) OBJECTIVE LENS HOLDER, OBJECTIVE LENS DRIVING DEVICE, OPTICAL PICKUP DEVICE, AND METHOD FOR MANUFACTURING OBJECTIVE LENS DRIVING DEVICE

(71) Applicants: Shingo MATSUZAKI, Ora-gun (JP); Shunichi Morimoto, Ota-shi (JP); Noboru Tajiri, Ora-gun (JP)

(72) Inventors: Shingo MATSUZAKI, Ora-gun (JP); Shunichi Morimoto, Ota-shi (JP); Noboru Tajiri, Ora-gun (JP)

(73) Assignee: SANYO ELECTRIC CO., LTD., Moriguchi-city (JP)

(21) Appl. No.: 13/595,521

(22) Filed: Aug. 27, 2012

(30) Foreign Application Priority Data
Aug. 29, 2011 (JP) 2011-186194
Dec. 2, 2011 (JP) 2011-264212

(51) Int. Cl. G02B 7/04; B32B 37/12; G11B 7/1374

(52) U.S. Cl. 369/112.23; 359/824; 156/60; 156/185; G9B/7.121

(57) ABSTRACT

Provided are a small objective lens (OBL) holder in which coils can be easily incorporated, and the like. An OBL holder of the present invention includes: a main surface portion provided with a circular opening portion in which an objective lens is fixed; and four side wall portions integrally extending downward from a peripheral portion of the main surface portion. The side wall portions include: a first side-wall portion extending in a longitudinal direction of the OBL holder; a second side-wall portion opposed to the first side-wall portion; a third side-wall portion extending in a short-side direction of the OBL holder; and a fourth side-wall portion, which are provided on the rear, front, right and left sides in the drawing, respectively. Accommodation regions capable of accommodating focusing coils are arranged on one side and the other side of the objective lens.

This application claims priority from Japanese Patent Application Number JP 2011-186194 filed on Aug. 29, 2011, JP 2011-264212 filed on Dec. 2, 2011, the content of which are incorporated herein by reference in its entirety.

### BACKGROUND OF THE INVENTION

1. Field of the Invention

The present invention relates to an objective lens holder to which an objective lens is attached, an objective lens driving device in which the objective lens holder is supported movably relative to an actuator frame, an optical pickup device, and a method for manufacturing the objective lens driving device. The present invention particularly relates to an objective lens holder and the like having a focusing coil incorporated therein.

2. Description of the Related Art

In an objective lens driving device in an optical head configured to optically read and write a signal from and to an optical disc, an objective lens holder (hereinafter referred to as an OBL holder) with an objective lens attached thereto is supported movably relative to an actuator frame. Focusing coils and tracking coils, and tilt coils as necessary are attached to the OBL holder, and effective areas of these driving coils are arranged in certain magnetic fields generated by magnetic circuits. With this structure, the objective lens is driven according to signals provided to the driving coils.

Japanese Patent Application Publication No. 2008-152831 (Patent Document 1), for example, discloses a structure of a conventional objective lens driving device. As shown in FIG. 2 of Patent Document 1 and the description of FIG. 2, a lens holder 1 is provided with tracking coils 6, first focusing coils 7, second focusing coils 8, a first tilt coil 11, and a second tilt coil 12 on the side surfaces of the lens holder 1. These coils are operated by receiving predetermined control signals to perform focus control, tracking control and tilt control.

As seen from FIGS. 2 and 3 of Patent Document 1, the first and second tilt coils 11, 12 are formed to be wound around the entire side surfaces of the lens holder 1.

### SUMMARY OF THE INVENTION

In this respect, it is preferable to let a laser light beam in the inside of the lens holder 1 from its side surfaces for the purpose of the downsizing of an optical pickup device in which the lens holder 1. However, Patent Document 1 described above has a problem that it is difficult to achieve such a preferable structure, since the first and second tilt coils 11, 12 are formed to be wound around the entire side surfaces of the lens holder 1.

The present invention has been made in view of the aforementioned problem, and an object of the present invention is to provide a small objective lens holder in which coils can be easily incorporated, and the like.

An objective lens holder of the present invention is an objective lens holder which is movably supported by an objective lens driving device of an optical pickup device, the objective lens holder comprising: a main surface portion provided with a fixing unit on which an objective lens is fixed; a first side-wall portion and a second side-wall portion opposed to each other and each extending in a longitudinal direction of the objective lens holder; a third side-wall portion and a fourth side-wall portion opposed to each other and each extending in a short-side direction of the objective lens holder; a first accommodation region surrounded by the first side-wall portion, the second side-wall portion, and the third side-wall portion on one side of the fixing unit, a first focusing coil being accommodated in the first accommodation region, and a second accommodation region surrounded by the first side-wall portion, the second side-wall portion, and the fourth side-wall portion on the other side of the fixing unit, a second focusing coil being accommodated in the second accommodation region.

Moreover, an objective lens driving device of the present invention is that wherein the objective lens holder having the above configuration is movably supported by an actuator frame.

Further, an optical pickup device of the present invention is that wherein the objective lens driving device having the above configuration is disposed in a housing.

Furthermore, a method for manufacturing an objective lens driving device of the present invention comprises the steps of: preparing the objective lens holder according to claim 1; accommodating the first focusing coil in the first accommodation region by sliding the first focusing coil from a central portion of the objective lens holder to a peripheral portion thereof, and accommodating the second focusing coil in the second accommodation region by sliding the second focusing coil from the central portion of the objective lens holder to a peripheral portion thereof; and fixedly attaching the first focusing coil and the second focusing coil to the objective lens holder by supplying an adhesive to the first focusing coil and the second focusing coil.

### BRIEF DESCRIPTION OF THE DRAWINGS

FIG. 1 is a plan view showing an optical pickup device of a preferred embodiment of the invention.

FIG. 2A is a plan view showing an objective lens driving device of the preferred embodiment of the invention as a whole. FIG. 2B is a plan view showing an actuator movable part of the objective lens driving device in an enlarged manner.

FIG. 3A is a perspective view of an objective lens holder of the preferred embodiment of the invention in a state where various coils and the like are incorporated therein. FIG. 3B is a perspective view of an accommodation region in which a focusing coil is accommodated in an enlarged manner.

FIG. 4A is a perspective bottom view of the objective lens holder of the preferred embodiment of the invention in the state where the various coils are incorporated. FIG. 4B is a perspective bottom view of an accommodation region in which a focusing coil is accommodated.

FIG. 5A is a perspective top view of the accommodation region of the objective lens holder of the preferred embodiment of the invention. FIG. 5B is a perspective bottom view of the accommodation region.

FIGS. 6A and 6B are views showing a method for accommodating a focusing coil in the objective lens holder of the preferred embodiment of the invention.

FIG. 7 is a cross-sectional view showing a step of supplying an adhesive to the focusing coil accommodated in the objective lens holder of the preferred embodiment of the invention.

FIG. 8A is a perspective view of an objective lens holder of another embodiment of the invention. FIG. 8B is a perspective view showing a bobbin around which a focusing coil is wound. FIG. 8C is a plan view of the objective lens holder.

FIG. 9 is a perspective view showing a method for accommodating a focusing coil in the objective lens holder of the preferred embodiment of the invention.

### DESCRIPTION OF THE INVENTIONS

### First Embodiment

### Optical Pickup Device

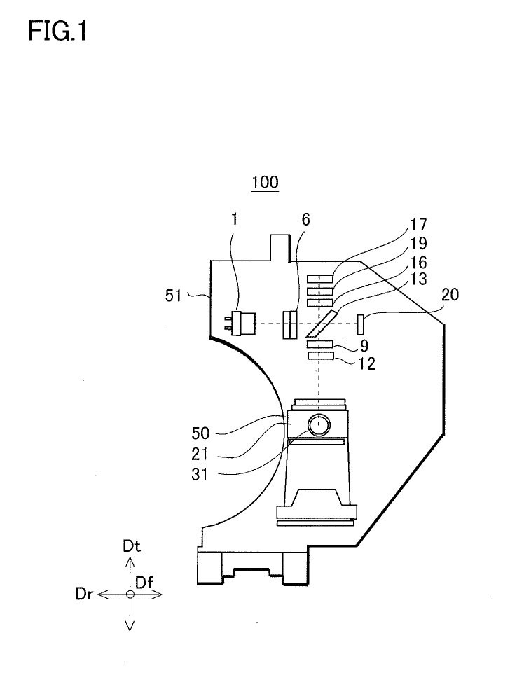

FIG. 1 is a plan view schematically showing an optical pickup device 100 of an embodiment.

The optical pickup device 100 is configured to support any optical disc compliant with compact disc (CD) standards, digital versatile disc (DVD) standards, and blu-ray disc (BD) standards, for example. The optical pickup device 100 includes an objective lens driving device 50 (an actuator) and various optical components placed in a housing 51. When being schematically described, a function of an optical pickup device is to read and write information from and to an optical disc by emitting a predetermined-standard-compliant laser light beam onto an information recording layer of the optical disc and then by receiving the reflected laser light beam from the information recording layer.

The objective lens driving device 50 movably holds an objective lens holder (hereinafter, an OBL holder) 21. An objective lens 31 compliant with any or all of the aforementioned standards is mounted on the OBL holder 21.

A laser unit 1 includes a laser diode which emits a laser light beam satisfying the aforementioned standards. Specifically, the laser diode emits a laser light beam in a blue-violet (blue) waveband of 395 nm to 420 nm (a wavelength of 405 nm, for example) suitable for a BD, a laser light beam in a red waveband of 645 nm to 675 nm (a wavelength of 650 nm, for example) suitable for a DVD or a laser light beam in a infrared waveband of 765 nm to 805 nm (a wavelength of 780 nm, for example) suitable for a CD.

The laser light beam emitted from the laser unit 1 is separated into a zero-order beam, a first positive order beam, and a first negative order beam by a diffraction grating 6. The light beams are reflected by a semitransparent mirror 13, pass through a quarter wave plate 9 and a collimating lens 12, are reflected by an unillustrated reflecting mirror, and then are focused on an information recording layer of the optical disk by the objective lens 31. Part of the laser light beam emitted from the laser unit 1 passes through the semitransparent mirror 13 and detected by an FMD 20. Based on the detection, output of the laser unit 1 is controlled. The return laser light beam reflected by the information recording layer of the optical disc is transmitted through the reflecting mirror, the collimating lens 12, the quarter wave plate 9, and the semitransparent mirror 13. Thereafter, undesired astigmatism on the return laser light beam is eliminated by a first plate 16 and a second plate 19, desired astigmatism is provided thereto, and then the return laser light beam is detected by an optical detector 17 (PDIC). Based on a signal detected by the optical detector 17, a control signal is supplied to a corresponding one of focusing coils, tracking coils or tilt coils in the OBL holder 21, so that a control current is supplied to the corresponding coil. As a result, focus control, tracking control or radial tilt control is performed. Here, the focusing coils also function as the tilt coils in the objective lens driving device 50 to be described later, and thus the tilt coils are omitted therein.

Here, a Dt direction shown in FIG. 1 is a tangential direction, a Dr direction is a tracking direction (a radial direction of the optical disk), and a Df direction is a focusing direction. These directions are orthogonal to each other.

### Second Embodiment

### Objective Lens Driving Device

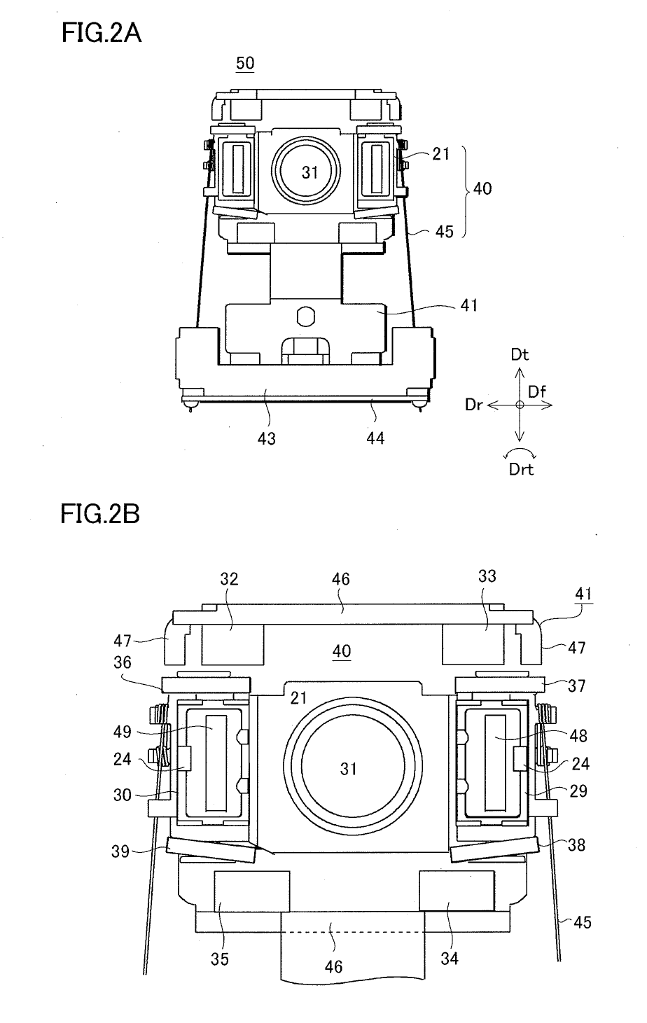

An objective lens driving device 50 incorporated in the aforementioned optical pickup device 100 will be described with reference to FIGS. 2A and 2B. FIG. 2A is a plan view showing the objective lens driving device 50, and FIG. 2B is a plan view showing an actuator movable part 40 in an enlarged manner.

With reference to FIG. 2A, the objective lens driving device 50 includes the actuator movable part 40 and an actuator frame 41. The actuator movable part 40 includes an OBL holder 21 and supporting wires 45. The actuator frame 41 is made of a magnetic metal material such as a silicon steel plate. The actuator frame 41 is machined to be partially bent at a right angle, and thereby yokes to be described later are formed.

The actuator movable part 40 is elastically supported by the supporting wires 45 to be movable relative to the actuator frame 41 in the focusing direction (the Df direction), the tracking direction (the Dr direction) and a radially tilting direction (a Drt direction). One end of each supporting wire 45 is fixed on a side wall of the OBL holder 21, and the other end thereof is fixed on a fixed board 44 fixed on the actuator frame 41. The fixed board 44 is attached to an auxiliary member 43 into which a damper material for damping vibrations of the supporting wire 45 is filled, and is screwed and fixed on the actuator frame 41 together with the auxiliary member 43. The supporting wires 45 are provided in three, for example, on each side surface of the actuator frame 41 to mechanically support the actuator movable part 40 in the air. The supporting wires 45 also function as connection means for allowing currents supplied to the coils provided in the actuator movable part 40.

With reference to FIG. 2B, the actuator movable part 40 mainly includes the OBL holder 21, an objective lens 31 fixed on an upper surface of the OBL holder 21, tracking coils 36, 37, 38, 39 wound around outer surfaces of side-wall portions of the OBL holder 21, and focusing coils 29, 30 incorporated in the OBL holder 21.

Magnets 32, 33, 34, 35 are arranged on yokes of the actuator frame 41 which face the tracking coils 36 to 39 arranged on the outer side of the side-wall portions of the OBL holder 21. Surfaces, of the magnets 32 to 35, facing the tracking coils 36 to 39 have the same polarity (the N polarity, for example). The magnets 32 to 35 generate effective magnetic flux on effective areas of the tracking coils 36 to 39. When currents are supplied to the tracking coils 36 to 39 in such a structure, the OBL holder 21 is moved in the Dt direction due to cooperation of magnetic fields generated by flowing of the currents through the tracking coils 36 to 39 and magnetic circuits generated by magnetic fields generated by the magnets 32 to 35.

The two focusing coils 29, 30 each having a winding axis in the Df direction are arranged at positions across the objective lens 31 inside the OBL holder 21. The magnets 32 to 35 generate the effective magnetic flux also on effective areas of the focusing coils 29, 30. Accordingly, when currents are supplied to the focusing coils 29, 30, the OBL holder 21 is moved in the Df direction due to cooperation of magnetic fields generated by flowing of the currents through the focusing coils 29, 30 and magnetic circuits generated by magnetic fields generated by the magnets 32 to 35. Note that in this embodiment, the OBL holder 21 is controlled to be moved in the tilting direction (the Drt direction) by providing the focusing coils 29, 30 with control signals for the control of movement in the tilting direction.

A back yoke 46 is a portion obtained by machining and bending an end portion of the actuator frame 41 at a right angle, and the magnets 32, 33 are fixedly attached to a side surface of the back yoke 46. Further, sub-yokes 47 are formed by further bending, at a right angle, end portions of the back yoke 46 in the Dr direction. Providing the back yoke 46 and the sub-yokes 47 enhances the effective magnetic flux effectively acting on the tracking coils 36, 37, and is effective to enhance the sensitivity of the OBL holder 21 in the Dt direction.

Opposed yokes 48, 49 are portions formed by bending the actuator frame 41 at a right angle like the back yoke 46 and the like, and are respectively provided at positions inside the focusing coils 29, 30. Arranging the opposed yokes 48, 49 like this makes it possible to enhance the effective magnetic flux effectively acting on the focusing coils 29, and the tracking coils 36 to 39 and is effective to enhance the sensitivity of the OBL holder 21 in the Df, Dr, and Drt directions.

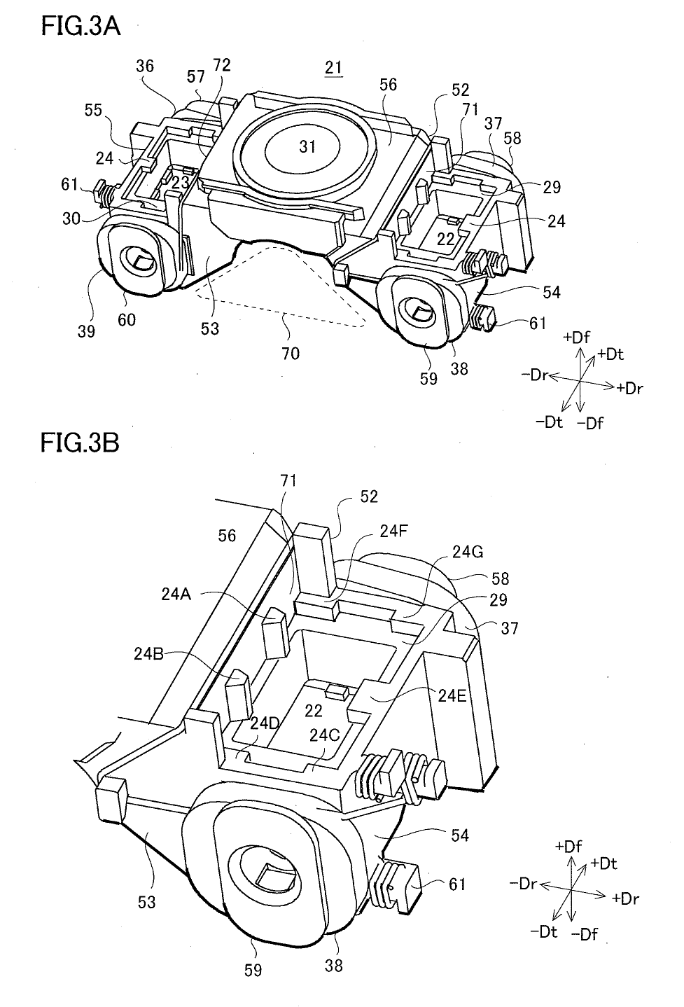

Further, in this embodiment, the focusing coils 29, 30 are arranged at positions across the objective lens 31 in the Dr direction and are fixed by supporting portions 24 at the positions. This is a feature of this embodiment and will be described later with reference to the drawings following FIG. 3A.

### Third Embodiment

### Objective Lens Holder

A structure of an OBL holder 21 provided with focusing coils 29, 30 and tracking coils 36, 37, 38, 39 will be described with reference to FIGS. 3A and 3B. FIG. 3A is a perspective view showing the OBL holder 21 provided with the coils 29, 30 and 36 to 39, and FIG. 3B is a perspective view showing an accommodation region 22 in which the focusing coil 29 is accommodated in the enlarged manner.

The schematic shape of the OBL holder 21 is an enclosure shape with an opening portion provided in a lower portion thereof. Specifically, the OBL holder 21 includes: a main surface portion 56 having a circular opening into which an objective lens 31 is mounted; and four side-wall portions continuously and integrally extending from a peripheral portion of the main surface portion 56. The side-wall portions include: a first side-wall portion 52 extending in a longitudinal direction of the OBL holder 21 on the backside of the drawing; a second side-wall portion 53 opposed to the first side-wall portion 52 on the front side of the drawing; a third side-wall portion 54 in a short-side direction of the OBL holder 21 on the right side of the drawing; and a fourth side-wall portion 55 provided on an end portion of the OBL holder 21 on the left side of the drawing. Main surfaces of the first side-wall portion 52 and the second side-wall portion 53 are parallel to the Dt direction, and main surfaces of the third side-wall portion 54 and the fourth side-wall portion 55 are parallel to the Dr direction.

Bobbins 57, 58 are provided on the main surface of the first side-wall portion 52 on the outside thereof, and the tracking coils 36, 37 are wound around the bobbins 57, 58, respectively. Bobbins 59, 60 are provided on the main surface of the second side-wall portion 53 on the outside thereof, and the tracking coils 38, 39 are wound around the bobbins 59, 60, respectively. The bobbins 57 to 60 are arranged in end portions located outside the objective lens 31 in the Dr direction. This is because, when the OBL holder 21 is accommodated in a small optical pickup, the reflecting mirror is arranged immediately below the objective lens 31, and a space 70 for securing an optical path to the reflecting mirror needs to be provided in a region ranging from the center to below the first side-wall portion 52 or the second side-wall portion 53 of the OBL holder 21. Thus, the region has no margin for accommodating the components such as the coils.

The tracking coils 36 to 39 wound around the respective bobbins 57 to 60 are formed by a single thin and long lead wire, such as an enameled wire, on which an insulating coating is formed. One end of the wire is wound around one of winding portions 61 formed by protruding a portion of the third side-wall portion 54, and the other end is wound around one of winding portions 61 provided on the fourth side-wall portion 55. Here, each of the tracking coils 36 to 39 has a winding axis in the Dt direction and is wound around a corresponding one of the bobbins 57 to 60 to shape a rectangle as a whole with its corners rounded. The tracking coils 36 to 39 are driving coils for driving the OBL holder 21 itself by using a magnetic effect. The focusing coils 29, 30 to be described later also have such a function.

The winding portions 61 are provided in three on the third side-wall portion 54. Ends of an insulating coating-formed lead wire such as an enameled wire forming the focusing coil 29 are wound around the respective two of the winding portions 61, while the one end of each of the tracking coils 36 to 39 is wound around on the rest one of the winding portions 61. Likewise, the winding portions 61 are provided in three on the fourth side-wall portion 55. Ends of a lead wire forming the focusing coil 30 are wound around the respective two of the winding portions 61, while the other end of each of the tracking coils 36 to 39 is wound around on the rest one of the winding portions 61. The lead wires wound around the winding portions 61 are connected to the supporting wires 45 shown in FIG. 2A.

Each of the focusing coils 29, 30 has a winding axis in the Df direction, is formed by winding a lead wire to shape a rectangle as a whole with its corners rounded, and accommodated inside the OBL holder 21. The focusing coil 29 is arranged in an accommodation region 22 provided in an end portion on the third side-wall portion 54 side, while the focusing coil 30 is arranged in an accommodation region 23 provided in an end portion on the fourth side-wall portion 55 side. In other words, the focusing coil 29 is provided on the +Dr side of the objective lens 31, while the focusing coil 30 is provided on the −Dr side of the objective lens 31. The reason why the accommodation regions 22, 23 for accommodating the focusing coils 29, 30 are arranged in the end portions outside an outer peripheral end portion of the objective lens 31 is the same as the aforementioned reason why the bobbins 57 to 60 are arranged in the end portions. Here, the sizes of the accommodation regions 22, 23 are set approximately equal to or slightly larger than the sizes of the accommodated focusing coils 29, 30 in a plan view.

Further, an upper portion of the accommodation region 22 is not covered with the main surface portion 56 and forms an opening portion (a first opening portion). Likewise, an upper portion of the accommodation region 23 forms an opening portion (a second opening portion). This allows the OBL holder 21 to move in the Df direction while an opposed yoke 48 shown in FIG. 2B is arranged inside the focusing coil 29. This also makes the OBL holder 21 lighter.

In this embodiment, as will be described later, parts of the side walls facing the accommodation regions 22, 23 are made to protrude inward to form the supporting portions 24 and the like, which support the focusing coils 29, 30. The accommodation regions 22, 23 have the same structure in which the focusing coils 29, 30 are supported by the supporting portions 24 and the like.

Note that the focusing coils 29, 30 and the tracking coils 36 to 39 are fixedly attached to the OBL holder 21 by using an adhesive supplied from the bobbins 57 to 60.

Further, an upper surface of the main surface portion 56 on which the objective lens 31 is arranged is located above upper end portions of the side-wall portions 54, 55 at positions where the accommodation regions 22, 23 are provided. This makes it possible to secure a sufficiently large region below the objective lens 31 to thereby arrange a reflecting mirror for reflecting a laser light beam in the region.

A fifth side-wall portion 71 extends downward from an end portion of the main surface portion 56 in a +Dr direction. Part of the fifth side-wall portion 71 protrudes in the +Dr direction to thereby form supporting portions supporting the focusing coil 29. Likewise, although being hidden in FIG. 3A, a sixth side-wall portion 72 extends downward from an end portion of the main surface portion 56 in a −Dr direction. Supporting portions supporting the focusing coil 30 are provided on the sixth side-wall portion 72.

As seen from FIG. 3B, the focusing coil 29 is accommodated in the accommodation region 22 surrounded by the first side-wall portion 52, the second side-wall portion 53, and the third side-wall portion 54. An upper end of the focusing coil 29 is supported by supporting portions 24A, 24B, 24C, 24D, 24E, 24F, and 24G. The supporting portions 24A to 24G are formed by making the side-wall portions of the OBL holder 21 protrude to the inside of the accommodation region 22.

Specifically, the supporting portions 24A, 24B partially protrude in the +Dr direction from a side surface of the fifth side-wall portion 71. Lower ends of the respective supporting portions 24A, 24B are in contact with the upper surface of the focusing coil 29. End portions of the respective supporting portions 24A, 24B in the +Dr direction protrude in the +Dr direction from an inner side surface of the focusing coil 29.

The supporting portions 24C, 24D protrude in a +Dt direction from an upper end portion of the second side-wall portion 53 facing the accommodation region 22, at positions near both end portions of the second side-wall portion 53, and lower surfaces of the respective supporting portions 24C, 24D are in contact with the upper surface of the focusing coil 29.

The supporting portion 24E protrudes in a −Dr direction from an upper end portion of the third side-wall portion 54. A lower surface of the supporting portion 24E supports the upper surface of the focusing coil 29. An end portion of the supporting portion 24E in the −Dr direction protrudes in the −Dr direction from an inner side surface of the focusing coil 29.

The supporting portions 24F, 24G protrude in a −Dt direction from an upper end portion of the first side-wall portion 52 facing the accommodation region 22, at positions near both end portions of the first side-wall portion 52, and lower surfaces of the respective supporting portions 24F, 24G are in contact with the upper surface of the focusing coil 29.

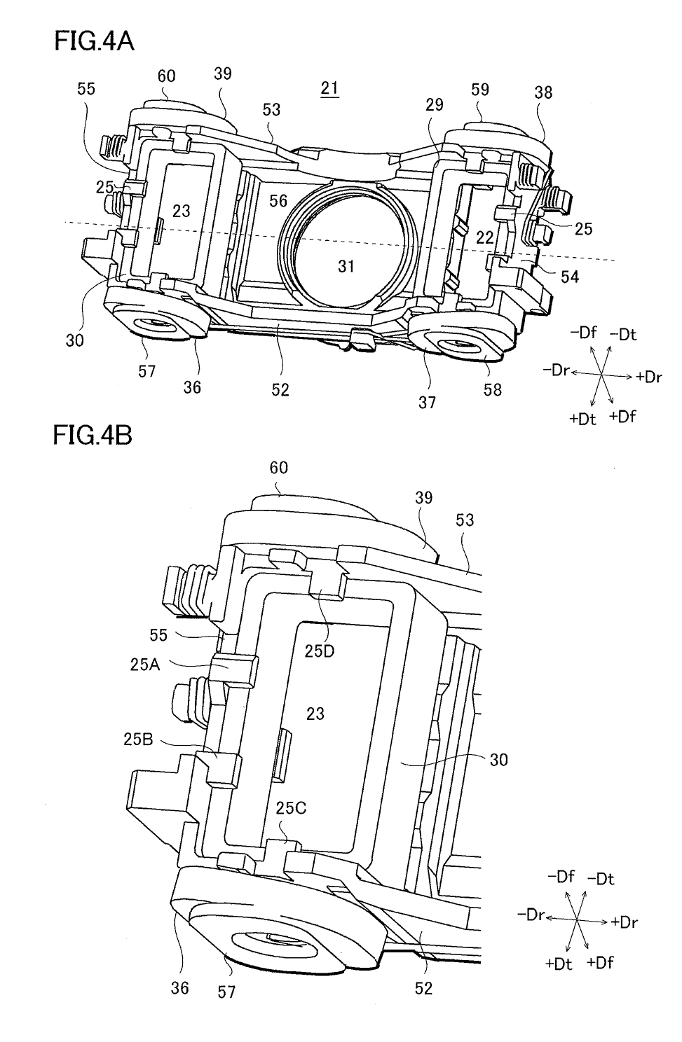

Next, a structure of supporting portions 25 supporting the focusing coils 29, 30 from below will be described with reference to FIGS. 4A and 4B. FIG. 4A is a perspective view of the OBL holder 21 seen from below, and FIG. 4B is a perspective view showing a state in which the focusing coil 30 is accommodated in the accommodation region 23. Note that FIG. 4A shows a state in which the OBL holder 21 shown in FIG. 3A is rotated at 180 degrees about an axis of a line (a dotted line) passing through the center of the objective lens 31 and parallel to the Dr direction.

As seen from FIG. 4A, end portions, in a −Df direction, of the respective focusing coils 29, 30 accommodated in the accommodation regions 22, 23 are supported by supporting portions 25 formed by making the side-wall portions partially protrude inward. Here, on the drawing plane, a right side wall, an upper side wall, and a lower side wall of the focusing coil 29 are in contact with inner side surfaces of the third side-wall portion 54, the second side-wall portion 53, and the first side-wall portion 52. In contrast, on the drawing plane, a left side wall, an upper side wall, and a lower side wall of the focusing coil 30 are in contact with inner side surfaces of the fourth side-wall portion 55, the second side-wall portion 53, and the first side-wall portion 52.

As seen from FIG. 4B, upper surfaces (bottom surfaces), on the drawing plane, of the focusing coil 30 accommodated in the accommodation region 23 are supported by supporting portions 25A, 25B, 25C, and 25D. Specifically, the supporting portions 25A, 25B are formed by making an end portion, in the −Df direction, of the fourth side-wall portion 55 facing the accommodation region 23 protrude in the −Dr direction. End portions of the respective supporting portions 25A, 25B in the −Dr direction protrude in the −Dr direction from an inner side surface of the tracking coil 36. With this structure, when the OBL holder 21 is excessively moved in the −Dr direction due to an impact or the like during use of an optical pickup device 100, the supporting portions 25A, 25B come into contact with an opposed yoke 49 (see FIG. 2B). Thus, deformation of the focusing coil 30 due to contact with the opposed yoke 49 is prevented.

The supporting portion 25C is formed by making an end portion, in the −Df direction, of the first side-wall portion 52 facing the accommodation region 23 protrude in the −Dt direction at a position near a central portion of the end portion. Further, the supporting portion 25D is formed by making an end portion, in the −Df direction, of the second side-wall portion 53 facing the accommodation region 23 protrude in the +Dt direction at a position near a central portion of the end portion.

Meanwhile, a side-wall portion of the focusing coil 30 in the +Dr direction is not in contact with the side-wall portion of the OBL holder 21. In other words, no side-wall portion of the OBL holder 21 is provided on the right side of the focusing coil 30 on the drawing plane. This is because the focusing coil 30 is inserted while being slid in the −Dr direction relative to the accommodation region 23 in this embodiment.

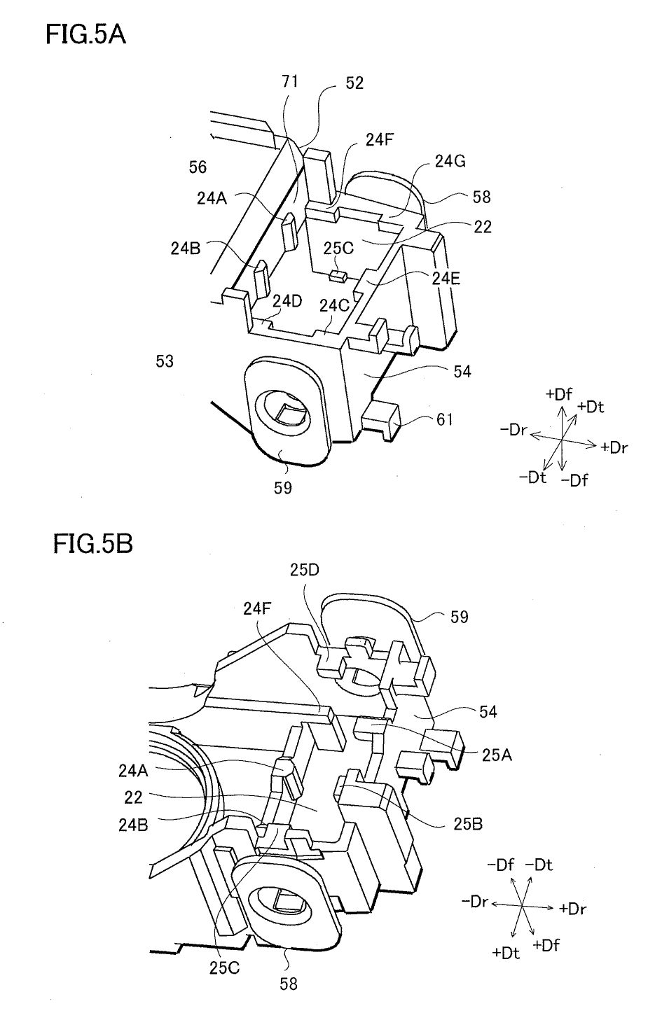

The accommodation region 23 in a state before the coils are provided therein will be described with reference to FIGS. 5A and 5B. FIG. 5A is a perspective view showing the accommodation region 22 of the objective lens holder 21, and FIG. 5B is a perspective view showing a state where the OBL holder 21 shown in FIG. 5A is rotated at 180 degrees about the Dr axis as a rotation axis.

As seen from FIG. 5A, the two supporting portions 24F, 24G are provided on the upper end of the first side-wall portion 52 facing the accommodation region 22, and the one supporting portion 25C is provided near the lower end thereof. Here, from a viewpoint of the Dr direction, the supporting portion 25C is arranged between the supporting portion 24F and the supporting portion 24G. Thereby, the focusing coil 29 accommodated in the accommodation region 22 is stably supported by these supporting portions 24F, 24G and 25C. This also holds true for the supporting portions 24D, 24C (see FIG. 5B) provided on the second side-wall portion 53.

Hence, a bottom surface of the focusing coil 29 accommodated in the accommodation region 22 is also supported by supporting portions 25A, 25B, 25C, and 25D in the placement of the focusing coil 29 as in the focusing coil 30. Specifically, the supporting portions 25A, 25B are formed by making an end portion, in the −Df direction, of the third side-wall portion 54 facing the accommodation region 22 protrude in the −Dr direction. End portions of the respective supporting portions 25A, 25B in the −Dr direction protrude in the −Dr direction from an inner side surface of the tracking coil 37. With this structure, when the OBL holder 21 is excessively moved in the −Dr direction due to an impact or the like during use of the optical pickup device 100, the supporting portions 25A, 25B come into contact with an opposed yoke 48 (see FIG. 2B). Thus, deformation of the focusing coil 29 due to contact with the opposed yoke 48 is prevented.

The supporting portion 25C is formed by making an end portion, in the −Df direction, of the first side-wall portion 52 facing the accommodation region 22 protrude in the −Dt direction at a position near a central portion of the end portion. Further, the supporting portion 25D is formed by making an end portion, in the −Df direction, of the second side-wall portion 53 facing the accommodation region 22 protrude in the +Dt direction at a position near a central portion of the end portion.

Meanwhile, a side-wall portion of the focusing coil 29 in the −Dr direction is not in contact with the side-wall portion of the OBL holder 21. In other words, no side-wall portion of the OBL holder 21 is provided on the left side of the focusing coil 29 on the drawing plane. This is because the focusing coil 29 is inserted while being slid in the +Dr direction relative to the accommodation region 22 in this embodiment.

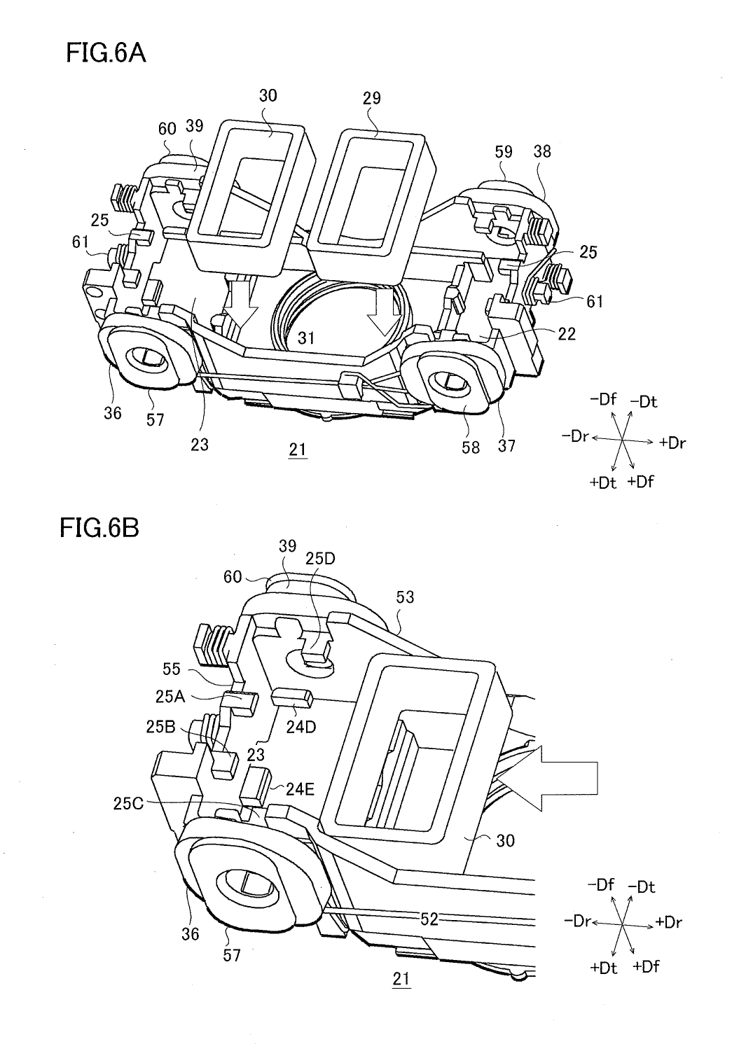

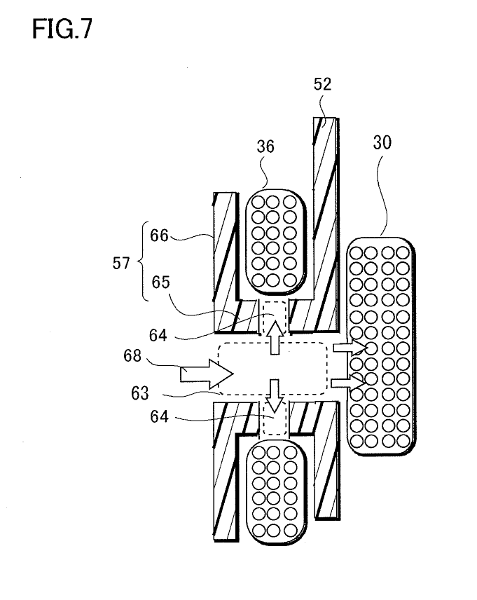

Next, a method for manufacturing an objective lens driving device in the aforementioned structure will be described with reference to FIGS. 6A to 7.

Firstly, an OBL holder 21 having a shape as shown in FIG. 6A is prepared. The OBL holder 21 is formed by injecting a resin material such as a liquid crystal polymer into a cavity of a mold. The OBL holder 21 has four side-wall portions, and bobbins 57, 58, 59, 60 around which tracking coils are wound are provided integrally with a first side-wall portion 52 and a second side-wall portion 53 of the four side-wall portions.

Next, tracking coils 36, 37, 38, 39 corresponding to bobbins 57, 58, 59, 60, respectively, are formed by winding a single lead wire around the bobbins 59, 58, 57, 60 in this order by an automated machine. One end of the lead wire forming the tracking coils 36 to 39 is wound around a winding portion 61 provided on a third side-wall portion 54, and the other end thereof is wound around a winding portion 61 provided on a fourth side-wall portion 55.

Then, focusing coils 29, 30 are accommodated in the OBL holder 21. FIG. 6A is a perspective view showing a step of accommodating the focusing coils 29, 30 inside the OBL holder 21, and FIG. 6B is a perspective view showing a step of sliding and inserting the focusing coil 30 into an accommodation region 23.

As described above, a space needs to be secured in the region above the objective lens 31, as shown in FIG. 6A, in the OBL holder 21 of this embodiment both to arrange the reflecting mirror and to secure an optical path of the laser light beam. In other words, focusing coils 29, 30 cannot be arranged in this region.

For this reason, accommodation of the focusing coils 29, 30 inside the OBL holder 21 needs to be performed at positions across the objective lens 31 in this embodiment. Here, in the first place, the focusing coils 29, 30 are temporarily accommodated in a region including the central portion of the OBL holder 21. The region is approximately large enough to temporarily accommodate the focusing coils 29, 30.

Next, as seen from FIG. 6B, the focusing coil 30 is slid toward the accommodation region 23 of the OBL holder 21. Specifically, an upper end of the focusing coil 30 is brought into contact with supporting portions 25A to 25D, while a lower end thereof is brought into contact with supporting portions 24A to 24G (see FIG. 5A). In this state, the focusing coil 30 is slid in the −Dr direction, until an outer side surface of the focusing coil 30 on the −Dr side comes into contact with an inner side surface of the fourth side-wall portion 55 of the OBL holder 21. Thereby, the focusing coil 30 is temporarily fixed in the accommodation region 23.

Likewise, as seen from FIG. 6A, the focusing coil 29 is slid and then temporarily fixed in an accommodation region 22 provided on the right side of the OBL holder 21.

Next, as seen from FIG. 7, an adhesive is supplied to fixedly attach the focusing coil 30 to the OBL holder 21.

Specifically, the bobbin 57 around which the tracking coil 36 is wound includes: a cylindrical portion 65 shaped into a cylinder protruding outward from a first side-wall portion 52; and a flange portion 66 formed by extending an outer end portion of the cylindrical portion 65. The cylindrical portion 65 has: a communication hole 63 therein which causes the OBL holder 21 and the outside to communicate with each other; and a through-hole 64 penetrating part of the cylindrical portion 65. The other bobbins 58 to 60 have the same structure.

In this step, an adhesive 68 in a liquid state is supplied to the communication hole 63. The adhesive 68 supplied to the communication hole 63 is impregnated into gaps created by a lead wire forming the focusing coil 30. In addition, some of the adhesive 68 enters between an inner wall of a first side-wall portion 52 and the focusing coil 30. Likewise, the adhesive 68 is supplied to the focusing coil 30 also from a bobbin 60 (see FIG. 6B) provided on a second side-wall portion 53. Since the bobbin 57 and the bobbin 60 are arranged symmetrically at positions across the focusing coil 30, the adhesive 68 supplied from the bobbins 57, 60 is impregnated into the focusing coil 30 evenly. Likewise, the adhesive 68 is supplied to a focusing coil 29 through bobbins 58, 59 (see FIG. 6A).

Some of the adhesive 68 supplied to the communication hole 63 is supplied to a tracking coil 38. Specifically, when being supplied to the communication hole 63 of the bobbin 57, the adhesive 68 in a liquid state enters a space surrounded by the flange portion 66 and the second side-wall portion 53 through the through-holes 64. Then, the thus entering adhesive 68 is impregnated into gaps created by the lead wire forming the tracking coil 38. The method for supplying the adhesive 68 to the tracking coil 38 is also applied to other bobbins 58, 59, 60.

Thereafter, the adhesive 68 is hardened. If the adhesive 68 is of a type to harden due to application of energy generated by beam irradiation, heating or the like, energy is applied to the adhesive 68. Thereby, with reference to FIG. 6B, portions of the lead wire forming the focusing coil 30 are solidified, and the focusing coil 30 is fixedly attached to the first side-wall portion 52, the second side-wall portion 53, and a fourth side-wall portion 55. Likewise, the focusing coil 30 are solidified, and fixedly attached thereto. Further, tracking coils 36 to 39 are solidified and fixedly attached to the bobbins 57 to 60, respectively.

The OBL holder 21 having the structure shown in FIGS. 3A and 3B is manufactured through the aforementioned steps. An objective lens driving device 50 is manufactured by fixing the OBL holder 21 on an actuator frame 41 by using supporting wires 45 as seen from FIGS. 2A and 2B. Further, an optical pickup device 100 is manufactured by incorporating the objective lens driving device 50 having such a structure into a housing 51 together with other optical devices, as seen from FIG. 1.

### Fourth Embodiment

### Objective Lens Holder of Another Embodiment

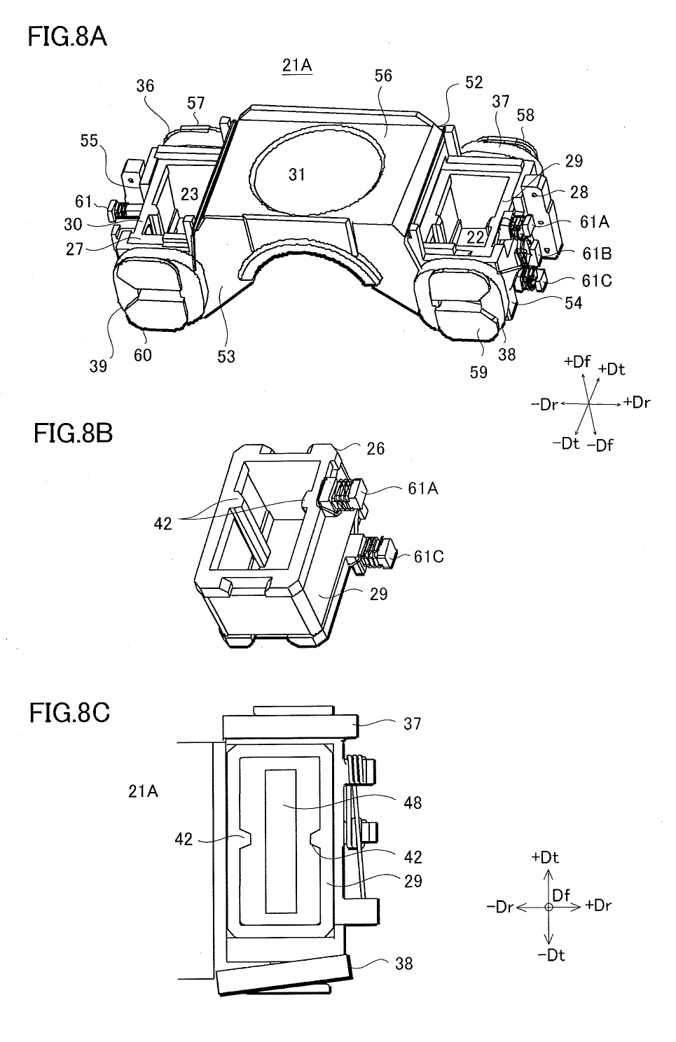

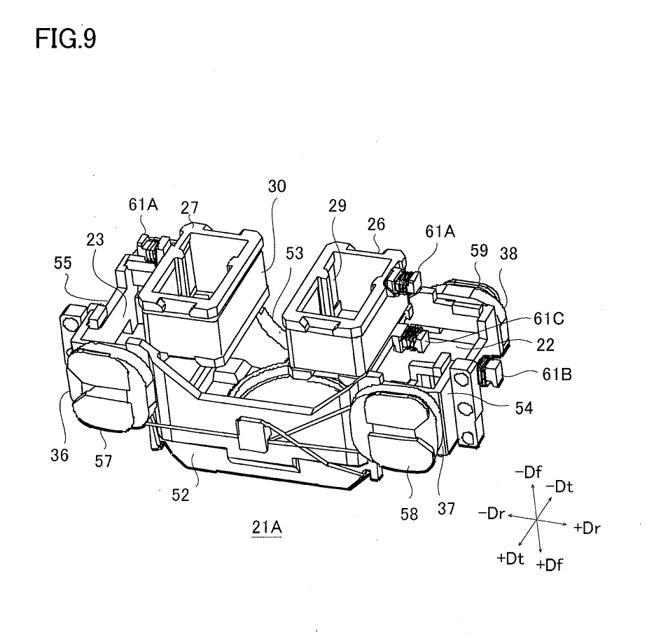

An OBL holder 21A of another embodiment will be described with reference to FIGS. 8A to 9. The OBL holder 21A to be described in this embodiment has the same basic structure as that described above in Third Embodiment but is different in that focusing coils 29, 30 are wound around bobbins 26, 27, respectively.

The structure of the OBL holder 21A will be described with reference to FIGS. 8A to 8C. FIG. 8A is a perspective view showing the OBL holder 21A as a whole, FIG. 8B is a perspective view showing the bobbin 26 around which the focusing coil 29 is wound, and FIG. 8C is a plan view showing part of the OBL holder 21A.

In Third Embodiment described above, the focusing coils 29, 30 formed by winding the lead wires are arranged at the predetermined positions in the OBL holder 21 as seen from FIG. 4A and the like.

In this embodiment, in order to further enhance the quality of a completed product, the focusing coil 29 wound around the bobbin 26 is prepared and then accommodated in the OBL holder 21A in the wound state, as shown in FIG. 8B.

Specifically, as seen from FIG. 8B, the bobbin 26 has a schematic box shape with upper and bottom portions opened, and a lead wire forming the focusing coil 29 is wound around a side surface portion of the bobbin 26. The side surface portion of the bobbin 26 is formed to be recessed in its middle portion from its upper and lower end portions. The focusing coil 29 is wound around the recessed portion. Further, the contour of the bobbin 26 has approximately the same size as that of the inside of the accommodation region 22 of the OBL holder 21 shown in FIG. 8A. By fitting the bobbin 26 in the accommodation region 22, the focusing coil 29 is fixed in the OBL holder 21A accurately in position. Note that the bobbin 26 may be made of the same resin or metal material as that of the OBL holder 21A, but use of a material having relatively small specific gravity contributes to reduction of a total weight of the OBL holder 21A.

Winding portions 61A, 61C are formed in a middle portion of a side of the bobbin 26 by making portions near upper and lower end portions protrude to the +Dr side to have a hook shape. One end of the lead wire forming the focusing coil 29 is wound around the winding portion 61A, while the other end thereof is wound around the winding portion 61C. In contrast, one end of tracking coils is wound around a winding portion 61B formed by making a third side-wall portion 54 of the OBL holder 21A protrude.

In addition, protrusions 42 are provided by respectively making inner walls of the bobbin 26 which face each other in the Dr direction protrude inward at positions near the central portions of the inner walls. Here, the protrusions 42 are each formed in a straight line, being continuous from an upper end of the bobbin 26 to a lower end thereof. As seen from FIG. 8C, providing the protrusions 42 in such a manner makes it possible to control moving amount of the OBL holder 21A in the Dr direction during use of an optical pickup device 100. Specifically, when currents flow through tracking coils 37, 38 during use of the optical pickup device 100, the OBL holder 21A is thereby moved in the Dr direction. When the moving amount of the OBL holder 21A increases to a predetermined amount or larger, any one of the protrusions 42 comes in contact with an opposed yoke 48, so that excessive moving in the Dr direction is prevented.

A focusing coil 30 provided on the left side on a drawing plane of FIG. 8A is also accommodated in an accommodation region 23 while being wound around the bobbin 27 like the focusing coil 29. Here, the bobbin 26 and bobbin 27 have the same shape but are different from each other only in a direction of being fitted into the OBL holder 21A. Thereby, in providing bobbins to incorporate the focusing coils 29, 30 into the OBL holder 21A, what is required is providing two bobbins of only one type. Thus, a cost increase due to use of bobbins is prevented.

A method for incorporating the aforementioned focusing coils 29, 30 into the OBL holder 21A will be described with reference to FIG. 9.

Firstly, a focusing coil 29 is prepared in a state of being wound around a bobbin 26, and then accommodated in an accommodation region 22 while being slid in the +Dr direction from a region including a central portion of the OBL holder 21A. The sliding is continued until an outer side surface of the bobbin 26 on the +Dr side comes into contact with an inner side surface of a third side-wall portion 54 of the OBL holder 21A. Thereby, outer side surfaces of the bobbin 26 come into contact with a first side-wall portion 52, the third side-wall portion 54, and a second side-wall portion 53 to be fixed in the accommodation region 22. In addition, by supplying an adhesive between the bobbin 26 and an inner wall of the OBL holder 21A, the position of the bobbin 26 is fixed. Winding portions 61A, 61C of the bobbin 26 protrude in the +Dr direction from the third side-wall portion 54.

A focusing coil 30 is also fixed in an accommodation region 23 of the OBL holder 21A in the same manner as in the focusing coil 29. Specifically, a bobbin 27 around which the focusing coil 30 is wound is placed in a region including a central portion of the OBL holder 21A, and then is slid in the −Dr direction until the bobbin 27 reaches an inner side surface of a fourth side-wall portion 55. Thereby, side surfaces of the bobbin 27 come into contact with respective inner side surfaces of the fourth side-wall portion 55, the first side-wall portion 52, and the second side-wall portion 53 in the accommodation region 23, so that the position of the bobbin 27 is fixed.

As described above, the focusing coils 29, 30 are incorporated into the OBL holder 21A while being wound around the bobbins 26, 27, respectively. This makes it possible to incorporate the focusing coils 29, 30 into the OBL holder 21A with positioning accuracy on a component basis, thus increasing the accuracy of the position of the focusing coils 29, 30.

Further, this makes it possible to incorporate the focusing coils 29, 30 into the OBL holder 21A without use of any dedicated jig, thus contributing to manufacturing cost reduction.

According to the preferred embodiments of the invention, in the objective lens holder, the first accommodation region in which the first focusing coil is to be accommodated is provided on the one side of the objective lens, and the second accommodation region in which the second focusing coil is to be accommodated is provided on the other side thereof. This makes it possible to secure a space for arranging a reflecting mirror below the objective lens, and to guide a laser light beam to the inside of the objective lens holder through a cut-out portion provided in part of a side wall of the objective lens holder.

What is claimed is:

1. An objective lens holder which is movably supported by an objective lens driving device of an optical pickup device, the objective lens holder comprising:
a main surface portion provided with a fixing unit on which an objective lens is fixed;
a first side-wall portion and a second side-wall portion opposed to each other and each extending in a longitudinal direction of the objective lens holder;
a third side-wall portion and a fourth side-wall portion opposed to each other and each extending in a short-side direction of the objective lens holder;
a first accommodation region surrounded by the first side-wall portion, the second side-wall portion, and the third side-wall portion on one side of the fixing unit, a first focusing coil being accommodated in the first accommodation region, and
a second accommodation region surrounded by the first side-wall portion, the second side-wall portion, and the fourth side-wall portion on the other side of the fixing unit, a second focusing coil being accommodated in the second accommodation region.

2. The objective lens holder according to claim 1, further comprising:
a supporting portion provided in the first accommodation region and configured to support the first focusing coil by protruding inward from an inner wall of at least one of the first, second and third side-wall portions; and
a supporting portion provided in the second accommodation region and configured to support the second focusing coil by protruding inward from an inner wall of at least one of the first, second and fourth side-wall portions.

3. The objective lens holder according to claim 2, wherein inner end portions of the supporting portions protrude inward from inner side surfaces of the first focusing coil and the second focusing coil, respectively.

4. The objective lens holder according to claim 1, wherein
a first opening portion not covered with the main surface portion is provided at a position where the first accommodation region is arranged, and
a second opening portion not covered with the main surface portion is provided at a position where the second accommodation region is arranged.

5. The objective lens holder according to claim 4, further comprising:
a fifth side-wall portion continuous from an end portion of the main surface portion and facing the first opening portion, and
a sixth side-wall portion continuous from an opposite end portion of the main surface portion and facing the second opening portion, wherein
a side surface of each of the fifth side-wall portion and the sixth side-wall portion is formed to protrude, thereby forming a supporting portion to support a corresponding one of the first focusing coil and the second focusing coil.

6. The objective lens holder according to claim 1, wherein a cut-out portion is provided by cutting out a part of the first side-wall portion or the second side-wall portion where the objective lens is arranged.

7. The objective lens holder according to claim 1, wherein the first focusing coil and the second focusing coil wound around focusing bobbins are respectively accommodated in the first accommodation region and the second accommodation region.

8. The objective lens holder according to claim 7, wherein protrusions are provided in mutually facing inner walls of each of the focusing bobbins, the protrusions being portions of the inner walls protruding inward.

9. The objective lens holder according to claim 7, wherein a winding portion is provided on a side wall of each of the focusing bobbins, an end portion of a coil wire of each focusing coil being wound around the winding portion.

10. An objective lens driving device in which the objective lens holder according to claim 1 is movably supported by an actuator frame.

11. An optical pickup device, wherein the objective lens driving device according to claim 10 is disposed in a housing.

12. A method for manufacturing an objective lens driving device, comprising the steps of:
preparing the objective lens holder according to claim 1;
accommodating the first focusing coil in the first accommodation region by sliding the first focusing coil from a central portion of the objective lens holder to a peripheral portion thereof, and accommodating the second focusing coil in the second accommodation region by sliding the second focusing coil from the central portion of the objective lens holder to a peripheral portion thereof; and
fixedly attaching the first focusing coil and the second focusing coil to the objective lens holder by supplying an adhesive to the first focusing coil and the second focusing coil.

13. The method for manufacturing an objective lens driving device according to claim 12, wherein
in the accommodation step, the first focusing coil and the second focusing coil respectively wound around bobbins are accommodated in the first accommodation region and the second accommodation region, respectively.
